(19) United States
(12) Patent Application Publication
(10) Pub. No.: US 2006/0023801 A1
(43) Pub. Date: Feb. 2, 2006

(54) Versatile system for optimizing transmit diversity in wireless communications

(76) Inventors: Jeffrey E. Taarud, Cardiff, CA (US); Manoneet Singh, Sunnyvale, CA (US)

Correspondence Address: TEXAS INSTRUMENTS INCORPORATED, P O BOX 655474, M/S 3999, DALLAS, TX, 75265, US

(21) Appl. No.: 11/191,475

(22) Filed: Jul. 28, 2005

Related U.S. Application Data
(60) Provisional application No. 60/592,301, filed on Jul. 28, 2004.

(51) Int. Cl. H04K 1/10

(52) U.S. Cl. 375/260

(57) ABSTRACT

The present invention provides a versatile system for optimizing pilot pattern diversity in a digital communications system—particularly in multiple antenna OFDM communications systems. According to the present invention, a receiving device within a communications system may receive transmissions from a first transmitting device (202) and a second transmitting device (204), on a single tone (214, 216) within a given time segment (206-212). The first transmitting device transmits a first pilot pattern to the receiving device on the tone. A differentiation scheme (200) is provided and utilized to transform a second pilot pattern from the second transmitting device, and the transformed second pilot pattern is transmitted to the receiving device on the tone.

### PRIORITY CLAIM

This application claims priority of U.S. Provisional Application No. 60/592,301, filed Jul. 28, 2004.

### TECHNICAL FIELD OF THE INVENTION

The present invention relates generally to the field of wireless communications and, more particularly, to constructs and methods for optimizing transmit diversity in multiple antenna systems through pilot pattern optimization.

### BACKGROUND OF THE INVENTION

Increasing demand for more powerful and convenient data and information communication has spawned a number of advancements in communications technologies, particularly in wireless communication technologies. A number of technologies have been developed to provide the convenience of wireless communication in a variety of applications, in various locations. This proliferation of wireless communication has given rise to a number of manufacturing and operational considerations.

Wireless LAN (WLAN) systems—based on standards such as IEEE 802.11(a), IEEE 802.11(g), and HiperLan/2—commonly use OFDM modulation to support high data rate transmission over a potentially fading multipath channel. In such systems, certain tones are reserved within each OFDM symbol in order to transmit known “pilot” information. For example, 4 out of 52 populated tones in an IEEE 802.11(a) data symbol carry pilot information. The purpose of transmitting these pilot tones is to enable continuous tracking of any potential phase or frequency drift between the receiver and the transmitter. Thus, these pilot tones thereby assist system synchronization, and improve overall performance.

In a number of wireless systems, multiple antennas are either desired or required at the transmitter, in order to increase the data rate, or to provide robustness against fading. In such systems, an issue arises of how pilot information may be distributed across all available antennas, for a given number of reserved pilot tones. If all available antennas transmit identical pilot information simultaneously on each reserved tone, a receiver does sees no transmit diversity benefit—since it essentially receives a composite channel that has the same fading characteristics as a channel between the receiver and any one of the transmit antennas. In other situations, different antennas may transmit signals that destructively interfere with one another, even to the point of being completely antiphase with respect to one another—causing difficulties for a receiver that may be unrecoverable.

As a result, there is a need for a system that provides optimal transmit diversity in a multiple antenna transmission system—one that provides robust system synchronization and optimal pilot pattern utilization—in an easy, efficient and cost-effective manner.

### SUMMARY OF THE INVENTION

The present invention provides a versatile system, comprising various constructs and methods, for creating robust transmission diversity in a multiple antenna wireless communication system. The system of the present invention obviates cumulative channel and destructive interference effects by providing a multi-dimensional alteration of transmit pilot patterns. The system of the present invention is readily scalable from two antenna systems to those that incorporate a large number of antennas, and may be implemented in a variety of system components or devices. The present invention thus overcomes a number of limitations inherent in conventional systems by providing optimal transmit diversity in an easy, efficient and cost-effective manner.

Specifically, the present invention provides a versatile system that maps pilot tone polarities from each transmit antenna in distinct and mathematically advantageous scheme—one that takes into account transmission frequency and time dimensions. This scheme obviates destructive interference problems, and a number of cumulative channel effects that negatively impact transmission diversity. The system of the present invention achieves this by deterministically introducing a variance element in the pilot tone transmission characteristics of all antennas within a given system.

More specifically, the present invention provides a versatile system for optimizing pilot pattern diversity in a digital communications system—particularly in multiple antenna OFDM communications systems. According to the present invention, a receiving device within a communications system may receive transmissions from a first transmitting device and a second transmitting device, on a single tone within a given time segment (e.g. OFDM symbol transmission). The first transmitting device transmits a first pilot pattern to the receiving device on the tone. A differentiation scheme is provided and utilized to transform a second pilot pattern from the second transmitting device, and the transformed second pilot pattern is transmitted to the receiving device on the same tone.

These and other features and advantages of the present invention will be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 provides an illustration depicting one embodiment of a communications system in accordance with certain aspects of the present invention; and

FIG. 2 provides an illustration depicting one embodiment of a differentiation scheme in accordance with certain aspects of the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The present invention is hereafter illustratively described primarily in conjunction with the design and operation of wireless LAN (WLAN) systems of the type defined by certain industry standards such as IEEE 802.11(a), IEEE 802.11(g), and HiperLan/2. Certain aspects of the present invention are further detailed in relation to certain design and operational considerations of Orthogonal Frequency Division Multiplexing (OFDM) communications systems. Although described in relation to such structures and protocols, the teachings and embodiments of the present invention may be beneficially implemented with a variety of data transmission or communication systems or protocols, depending upon the specific needs or requirements of such systems. The specific embodiments discussed herein are, therefore, merely demonstrative of specific ways to make and use the invention and do not limit the scope of the invention

The present invention provides a versatile system that creates, through a differentiation scheme, robust transmission diversity in a multiple antenna wireless communication system. The system of the present invention thereby obviates a number of cumulative channel and destructive interference effects, by providing a multi-dimensional alteration of transmit pilot patterns. The system of the present invention is readily scalable from two antenna systems to those that incorporate a large number of antennas, and may be implemented in a variety of system components or devices.

Specifically, the present invention provides a versatile system that maps pilot tone polarities from each transmit antenna in distinct and mathematically advantageous differentiation scheme—one that takes into account transmission frequency and time dimensions. This differentiation scheme deterministically introduces a variance element into the pilot tone transmission characteristics of each antenna within a given multi-antenna system.

The system of the present invention is particularly advantageous in systems having a “keyhole” channel arrangement—i.e., a channel in which the transmit (Tx) antennas are highly correlated. The present invention recognizes that in such a situation, for conventional applications, an identical signal transmitted from all antennas simultaneously could cause completely destructive interference and lead to a complete loss of received signal. In contrast, however, systems according to the present invention are immunized from such effects, since the present invention ensures that completely identical simultaneous transmission across all antennas does not occur on any given OFDM symbol. According to the present invention, at least one tone in each given OFDM symbol will not suffer from such destructive interference.

For purposes of explanation and illustration, it is useful to understand certain characteristics of an OFDM-based wireless communication system. OFDM-based systems transmit data in parallel over a given frequency bandwidth (i.e., channel). Each transmit and receive device pairing that exchanges data is generally considered to establish its own channel therebetween—even where a number of such pairings may be operating within the same given frequency bandwidth simultaneously. A given channel is typically divided into some number of tones or sub-carriers. For example, a given channel may have an assigned bandwidth of 20 MHz. That bandwidth may be divided into 64 sub-carriers, or tones, each of approximately 325 kHz in magnitude. Some of those tones are allocated as unused guard-band tones—typically the outermost four tones on each end of the 20 MHz band—leaving 52 of the 64 tones for active communication. Usually, four of those 52 tones are reserved as pilot tones—along which known information may be passed between a transmitter and receiver to establish and synchronize data transmissions on the remaining 48 data tones.

Contention or conflict issues can arise in systems where multiple devices are communicating, and more than one transmitting device is attempting to transmit to the same receiving device at the same time. An increasing number of receiving devices or systems are capable of receiving or processing data from multiple sources simultaneously. For transmitting large amounts of data, there may be a significant gain in transmission efficiency by transmitting smaller portions of that data from multiple antennas—achieving some “diversity gain.” This is a growing trend, especially as more and more wireless communication devices are being utilized in common areas. Even multiple antennas within a single device or system may be provided in an attempt to increase data throughput by utilizing diversity gain. Furthermore, diversity gain principles are commonly relied upon to overcome deleterious effects of signal fading on data transmissions.

If, however, more than one transmitting antenna initiates the same pilot tone sequence simultaneously, it is entirely possible that an intended receiver may see both such devices in a cumulative manner—and start receiving their respective data transmissions in a cumulative or destructive manner.

Conventionally, multiple antenna systems have relied—in large part—on spatial diversity principles as a remedy or “fix” for this issue. In other words, any potentially competing devices have been allowed to initiate simultaneous transmissions relying on the premise that small phase shifts—due to at least slightly different physical distances between a receiver and each transmitting device—would provide enough differentiation in pilot signals to allow a receiver to successfully distinguish between the transmitters. This type of approach is rapidly becoming insufficient as the volume and demands of wireless communication applications continue to grow.

In situations where there is direct and simultaneous conflict between two or more transmitting devices, a receiving device may experience a cumulative channel effect that renders the transmissions no more efficient than if transmitted from a single antenna. This becomes especially problematic when issues of signal fading arise. Where a receiver is, due to a cumulative channel effect, receiving an effective single channel, then any fading from the transmitting devices could cause signal and data integrity problems.

Comprehending these issues, the present invention recognizes the need for a pilot tone diversity scheme that obviates cumulative channel effects and enables a wireless communications system to realize optimal benefit from transmission diversity. The present invention thus provides a pilot pattern differentiation system for multiple antenna applications. The system of the present invention introduces a multi-dimensional differential into multiple antenna pilot pattern transmissions, such that even simultaneous and otherwise conflicting pilot transmissions may be distinguished, detected and fully received in a full diversity arrangement.

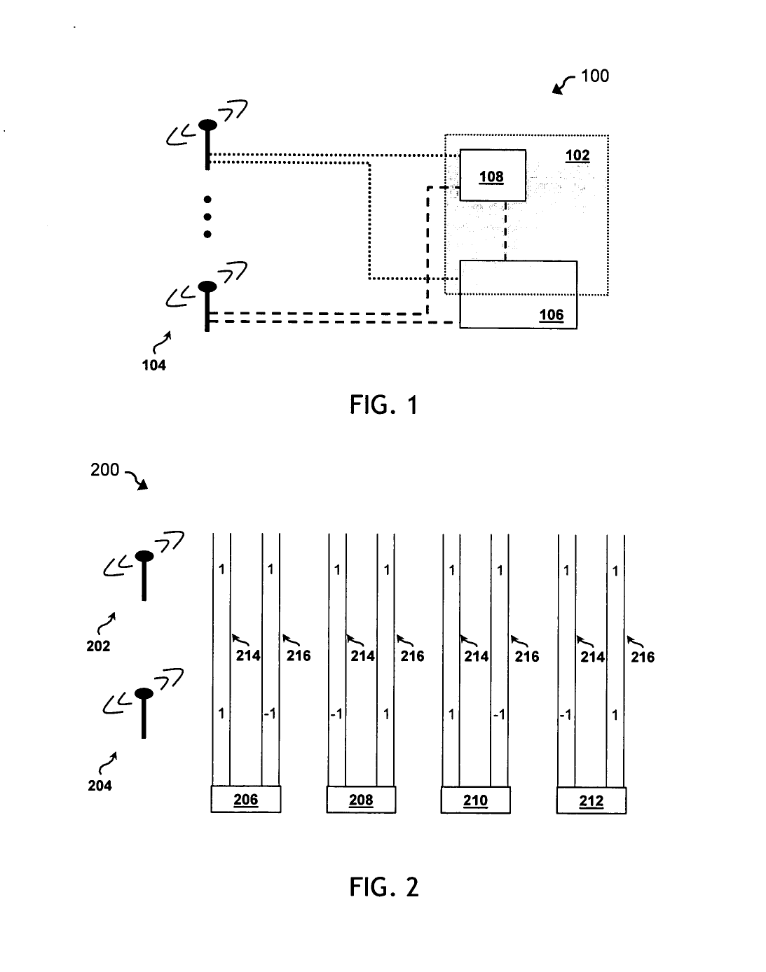

Certain aspects of the present invention are described in further detail now with reference to FIG. 1, which depicts an illustrative embodiment of a wireless communication system 100, according to the present invention. The present invention provides a differentiation construct 102 within system 100 that interacts with or arbitrates between multiple antennas 104. This construct implements a desired differentiation scheme 106, by modifying the operation of transmitting antennas 104 accordingly. Differentiation scheme 106 may be some fixed pattern or algorithm stored or residing wholly within construct 102, or scheme 106 may be some dynamic factor capable of real-time adjustment or alteration.

In its simplest form, scheme 106 may comprise some arbitration function 108 residing within construct 102 that restricts system 100 in such a way that only one antenna 104 is allowed to begin a pilot transmission on a given pilot tone within a given symbol. Thus, once construct 102 determines that one antenna 104 is initiating a pilot sequence on a given pilot tone within a given symbol, it asserts a signal or command that prohibits or voids a pilot sequence initiation from any other antenna on that tone during that symbol. This embodiment thus introduces transmission diversity between transmitters in the time dimension (per symbol basis).

In other embodiments, scheme 106 may comprise some other deterministic linear combination or transform that maps pilot tone polarities from each transmit antenna in a distinct and pre-determined manner—one that introduces transmission diversity between transmitters in both transmission frequency and time dimensions. In still other embodiments, scheme 106 may comprise some pseudo-random transform (e.g., pseudo-noise sequence) that maps pilot tone polarities from each transmit antenna in a pre-determined but effectively random manner. Other similar variations or various sub-combinations thereof are also comprehended.

One embodiment of a linear scheme is described now in reference to FIG. 2, which depicts diversity scheme 200, relating transmissions of a first antenna 202 and a second antenna 204 over a series of OFDM data symbols 206-212. For each data symbol, the transmissions on two pilot tones 214 and 216 are depicted—the tones reserved for transmitting pilot information in each of these OFDM symbols. Only two transmit antennas are shown, to simplify the presentation. Antenna 202 transmits a signal “1” on tones 214 and 216 during each symbol 206-212. Antenna 204 transmits “1” on tone 214 and “−1” on tone 216 during symbol 206. During symbol 208, antenna 204 transmits “−1” on tone 214 and “1” on tone 216, and continues cycling the polarity of its transmissions in this manner during subsequent symbols 210-212. By continuously reversing the polarity of transmissions from antenna 204, scheme 200 creates an order of diversity that is proportional to the number of transmit antennas multiplied by the number of reserved tones.

This approach is particularly useful in “keyhole” channels (i.e., channels in which Tx antennas are highly correlated). Scheme 200 and other similar embodiments ensure that destructive interference—caused by identical signal transmission from different antennas—does not occur on any given OFDM symbol. According to the present invention, at least one tone in each OFDM symbol is differentiated such that it will not suffer from destructive interference, thereby maintain transmission synchronization in each and every symbol.

In other embodiments, the present invention may be easily extended to address multiple transmit antennas, or multiple tones, over multiple OFDM symbols. Any suitable transform that provides the necessary or desired diversity may be employed. For example, in a system where there are 4 Tx antennas, the polarity of pilot tone transmissions over time and space can be altered according to a 4×4 Walsh-Hadamard matrix. This transform will provide an order of diversity equal to 4 times the number of reserved tones provided.

In still other embodiments, the present invention may provide extended diversity via a pseudo-random transform—such as a pseudo-noise (PN) sequence—that maps pilot tone polarities from each transmit antenna in a pre-determined but effectively random manner. For example, a first transmit antenna's transmissions may be transformed by pre-determined PN sequence. A second transmit antenna's transmissions may be transformed by the same pre-determined PN sequence, shift delayed from the first, or by a different pre-determined PN sequence. This same pattern may be extended to any number of antennas within the system.

Thus, the present invention transforms or otherwise modifies the pilot pattern transmission in a multiple antenna system—to optimize those patterns for providing extended transmit diversity. In all embodiments of the present invention, the constituent constructs, routines, functions or components may be implemented in a wide variety of ways—comprising various suitable software, firmware or hardware constructs, or combinations of thereof. For example, although construct 102 is depicted as a single separate entity, it is possible that certain embodiments may implement construct 102 within the host device of each individual antenna 104. Depending upon design requirements or constraints, certain algorithms and routines described herein may comprise firmware or separate code segments, grouped together in functional segments, or incorporated as part of a larger integrated code segment. They may comprise software operating on a host computer system, or routines operating on a digital signal processor. Certain functions or operations may be provided in exclusively in hardware. Various functions or constructs may be provided completely integrated, completely independent of one another, or in some combination therebetween. All of these variations, and all other similar variations and combinations, are comprehended by the present invention. All such embodiments may be employed to provide the benefits of the present invention.

The embodiments and examples set forth herein are therefore presented to best explain the present invention and its practical application, and to thereby enable those skilled in the art to make and utilize the invention. However, those skilled in the art will recognize that the foregoing description and examples have been presented for the purpose of illustration and example only. For example, aspects of the present invention have been described above in relation to WLAN, OFDM applications. The teachings and principles of the present invention are also applicable or adaptable to other applications or protocols. The description as set forth herein is therefore not intended to be exhaustive or to limit the invention to the precise form disclosed. As stated throughout, many modifications and variations are possible in light of the above teaching without departing from the spirit and scope of the following claims.

What is claimed is:

1. An OFDM digital communications system comprising:
a receiving device;
a first transmitting device, transmitting a first pilot pattern on a first tone to the receiving device;
a second transmitting device, transmitting a second pilot pattern on the first tone to the receiving device; and
a differentiation construct, adapted to transform polarity in one of the pilot patterns in such a manner that the receiving device realizes an order of diversity at least as great as the number of transmitting devices.

2. The system of claim 1, wherein the OFDM digital communications system comprises a WLAN system.

3. The system of claim 1, wherein the OFDM digital communications system comprises an IEEE 802.11 communications system.

4. The system of claim 1, wherein the OFDM digital communications system comprises a HiperLan/2 communications system.

5. The system of claim 1, wherein the differentiation construct comprises a differentiation scheme that defines a pilot pattern polarity transform.

6. The system of claim 5, wherein the differentiation scheme comprises a transform matrix.

7. The system of claim 5, wherein the differentiation scheme comprises a pseudo noise sequence.

8. The system of claim 5, wherein the differentiation scheme comprises a transmitting device switching arbitration.

9. The system of claim 5, wherein the differentiation scheme comprises a static scheme.

10. The system of claim 5, wherein the differentiation scheme comprises a dynamic scheme.

11. The system of claim 5, wherein the differentiation scheme comprises a Walsh-Hadamard matrix.

12. A method of optimizing pilot pattern diversity in a multiple antenna OFDM communications system, the method comprising the steps of:
providing a receiving device;
providing a first transmitting device;
providing a second transmitting device;
transmitting a first pilot pattern from the first transmitting device to the receiving device on a first tone;
providing a differentiation scheme;
utilizing the differentiation scheme to transform a second pilot pattern from the second transmitting device; and
transmitting the transformed second pilot pattern to the receiving device on the first tone.

13. The method of claim 12 wherein the step of providing a differentiation scheme further comprises providing a scheme to cycle polarity of the second pilot pattern.

14. The method of claim 12 wherein the step of providing a differentiation scheme further comprises providing a transform matrix.

15. The method of claim 12 wherein the step of providing a differentiation scheme further comprises providing a Walsh-Hadamard matrix.

16. The method of claim 12 wherein the step of providing a differentiation scheme further comprises providing a pseudo noise sequence.

17. The method of claim 12 wherein the step of providing a differentiation scheme further comprises providing a transmitting device switching arbitration.

18. The method of claim 12 further comprising the step of utilizing the differentiation scheme to transform the first pilot pattern from the first transmitting device, prior to transmitting the first pilot pattern.
